(19) United States
(12) Patent Application Publication
(10) Pub. No.: US 2025/0077426 A1
(43) Pub. Date: Mar. 6, 2025

(54) STORAGE MEDIUM, INFORMATION PROCESSING APPARATUS, AND CONTROLLING METHOD

(71) Applicant: CANON KABUSHIKI KAISHA, Tokyo (JP)

(72) Inventor: SHUUHEI KAWAKAMI, Tokyo (JP)

(21) Appl. No.: 18/820,416

(22) Filed: Aug. 30, 2024

(30) Foreign Application Priority Data
Sep. 6, 2023 (JP) 2023-144766

(51) Int. Cl. G06F 12/0802

(52) U.S. Cl. CPC G06F 12/0802; G06F 2212/60

(57) ABSTRACT

Provided is a non-transitory computer-readable storage medium storing a program for causing a computer to perform: accepting input of a first uniform resource locator (URL); and executing control to perform a process of obtaining a content available at the first URL in a case where the first URL does not match a second URL that had been input when the input of the first URL was accepted, and not to perform the process of obtaining the content available at the first URL in a case where the first URL matches the second URL.

### BACKGROUND OF THE INVENTION

### Field of the Invention

The present disclosure relates to a storage medium, an information processing apparatus, and a controlling method.

### Description of the Related Art

Some multi function peripherals (MFPs; hereinafter referred to as “image forming apparatuses”) having scanner and printer functions include web browsers. There are web browsers including an input box to input a connection destination's uniform resource locator (URL) (hereinafter referred to as “URL box”), and a button to accept a page update instruction from the user. There are web browsers which, in a case where the same connection URL is input into the URL box, always access the server, checks for an update for the web content, and displays the web content.

Japanese Patent Laid-Open No. 2003-330789 (Document 1) discloses a method in which a web content is saved in a cache, and the web content is read out of the cache in which the web content is saved and displayed in a case where an instruction to display the web content is accepted again from the user.

Here, in the method of Document 1, in a case where there is a cache for a web content available at an input connection URL, the web content is read out of the cache and displayed. Accordingly, there is a waiting time before the web content is displayed. This leads to a problem such as decreased user-friendliness.

### SUMMARY OF THE INVENTION

A non-transitory computer-readable storage medium according to an aspect of the present disclosure stores a program for causing a computer to perform: accepting input of a first URL; and executing control to perform a process of obtaining a content available at the first URL in a case where the first URL does not match a second URL that had been input when the input of the first URL was accepted, and not to perform the process of obtaining the content available at the first URL in a case where the first URL matches the second URL.

Further features of the present invention will become apparent from the following description of exemplary embodiments with reference to the attached drawings.

### BRIEF DESCRIPTION OF THE DRAWINGS

FIG. 1 is a diagram illustrating an example of an entire image processing system;

FIG. 2 is a block diagram illustrating an example of a configuration of an image forming apparatus;

FIG. 3 is a diagram illustrating an example of the software configuration of the image forming apparatus;

FIG. 4 is a flowchart illustrating an example of processing to be executed by a web browser;

FIGS. 5A and 5B are diagrams illustrating an example of the web browser;

FIG. 6 is a diagram illustrating an example of an URL information table;

FIG. 7 is a flowchart illustrating an example of a web content obtaining process;

FIG. 8 is a diagram illustrating an example of a request to be sent by the web browser;

FIGS. 9A and 9B are diagrams illustrating examples of a response to be received by the web browser;

FIG. 10 is a flowchart illustrating an example of processing to be executed by a web browser; and

FIG. 11 is a flowchart illustrating an example of processing to be executed by a web browser.

### DESCRIPTION OF THE EMBODIMENTS

Preferred embodiments of the present disclosure will be specifically described below with reference to the accompanying drawings. Note that the following embodiments do not limit the contents of the present disclosure, and not all of the combinations of the features described in the following embodiments are necessarily essential for the solution provided by the present disclosure. Meanwhile, the description will be given with the same reference sign given to identical components.

### First Embodiment

In a case of using an image forming apparatus including a web browser, the web browser displays a web content available at a connection URL in response to the user inputting this URL into the web browser's URL box. It is possible that the user then inputs the same connection URL into the URL box again. For example, the user may touch an operation unit displaying the web browser by mistake after inputting a connection URL into the URL box. In this case, the enter key of a software keyboard that has been activated may be pressed, thereby inputting the same connection URL. Inputting the same connection URL as that of the web content already displayed in the URL box can be considered an input error. Here, as described earlier, typical web browsers are configured such that, in a case where the same connection URL is input into the URL box, the web browsers always access the server, check for an update for the web content, and display the web content. A problem with this is that, in a case where the user inputs the same connection URL into the URL box again after inputting the connection URL, there will be a long waiting time required to display the web content to the user. A similar problem occurs also in a case of reading a cache for a web content that has already been obtained. In view of this, in the present embodiment, a description will be given of control by which, in a case where the same URL as a URL already input in an URL box is input, there will be no waiting time before the web content is displayed again.

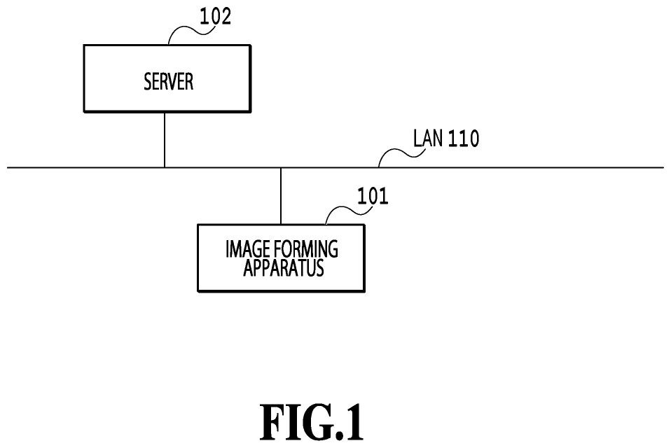

FIG. 1 is a diagram illustrating an example of an entire image processing system in the first embodiment. In the image processing system in the present disclosure, an image forming apparatus 101 and a server 102 are communicatively connected through a network 110. The image forming apparatus 101 includes a web browser 300 installed therein. Through the network 110, the web browser 300 sends a request to the server and receives a response to the request from the server to obtain a web content. The image forming apparatus 101 functions as a copying machine including as a printing apparatus that has a printing function of printing information on a print medium with printing agents, and further a reading apparatus that reads images on documents, or is an MFP additionally having another function(s). Note that various types of information processing apparatuses, such as a personal computer (PC), a smartphone, a tablet terminal, and a digital camera, can may be employed as the image forming apparatus 101 in the present embodiment.

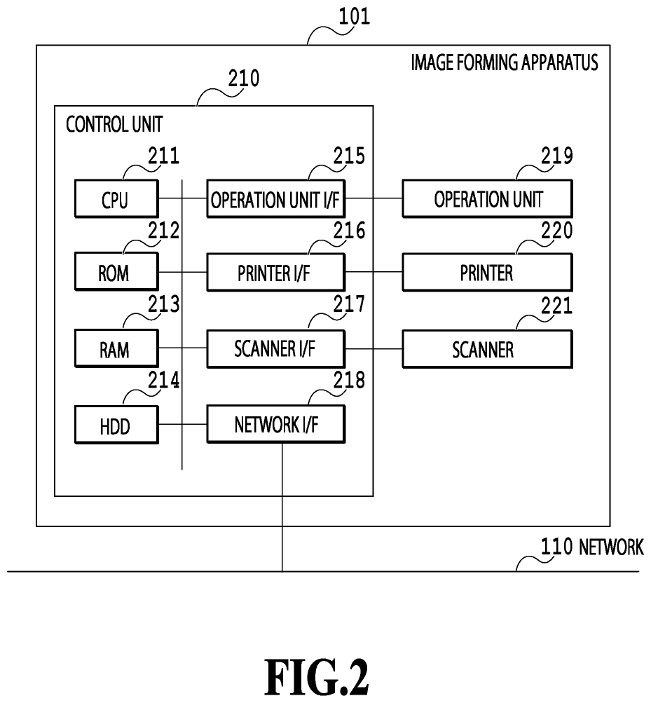

FIG. 2 is a block diagram illustrating an example of a configuration of the image forming apparatus 101. Details of the configuration of the image forming apparatus 101 will now be described with reference to FIG. 2.

The image forming apparatus 101 has a control unit 210, an operation unit 219, a printer 220, and a scanner 221. The control unit 210 has a central processing unit (CPU) 211, a read only memory (ROM) 212, and a random access memory (RAM) 213. The control unit 210 has a hard disk drive (HDD) 214, an operation unit interface (I/F) 215, a printer I/F 216, a scanner I/F 217, and a network I/F 218. The control unit 210, which includes the CPU 211, controls the operation of the entire image forming apparatus 101. The CPU 211 is a central processing unit, and executes various control processes such as reading out control programs stored in the ROM 212, controlling reading of responses, and controlling sending of requests. The RAM 213 is a main memory for the CPU 211, and is used as a temporary storage area such as a work area.

The HDD 214 stores various types of data such as image contents, image data, and various programs obtained from the server. The operation unit I/F 215 connects the operation unit 219 and the control unit 210. The operation unit 219 includes a liquid crystal display unit having a touch panel function, a keyboard having operation items such as an enter key, and the like. The keyboard may be a hardware keyboard or a software keyboard that is displayed on the liquid crystal display unit. Input data or a control instruction accepted by the operation unit 219 is input into the control unit 210 through the operation unit I/F 215. The printer I/F 216 connects the printer 220 and the control unit 210. The printer 220 executes a process of forming image data on a print medium (hereinafter referred to as “printing”). The image data to be printed by the printer 220 is transferred to the printer 220 from the control unit 210 through the printer I/F 216 and printed by the printer 220. The scanner I/F 217 connects the scanner 221 and the control unit 210. The scanner 221 reads an image on a document to generate image data and inputs this image data into the control unit 210 through the scanner I/F 217. The network I/F 218 connects the control unit 210 to the network 110.

Now, the obtaining of a web content will be specifically described. In a case where the user designates an URL address of an external apparatus as a connection destination in the network 110 on the web browser 300 displayed on the liquid crystal display unit of the operation unit 219, the web browser 300 sends a request to the external apparatus through the network I/F 218. Suppose that the external apparatus is the server 102. In this case, in response to receiving the request, the server 102 returns the corresponding web content as a response to the web browser 300. The web content as a response is usually described using HyperText Markup Language (HTML), Cascading Style Sheets (CSS), JavaScript, or the like. The web browser 300 converts the web content obtained from the server 102 into input fields and the like (generally called a browser rendering process or the like), and displays the rendering result on the liquid crystal display unit.

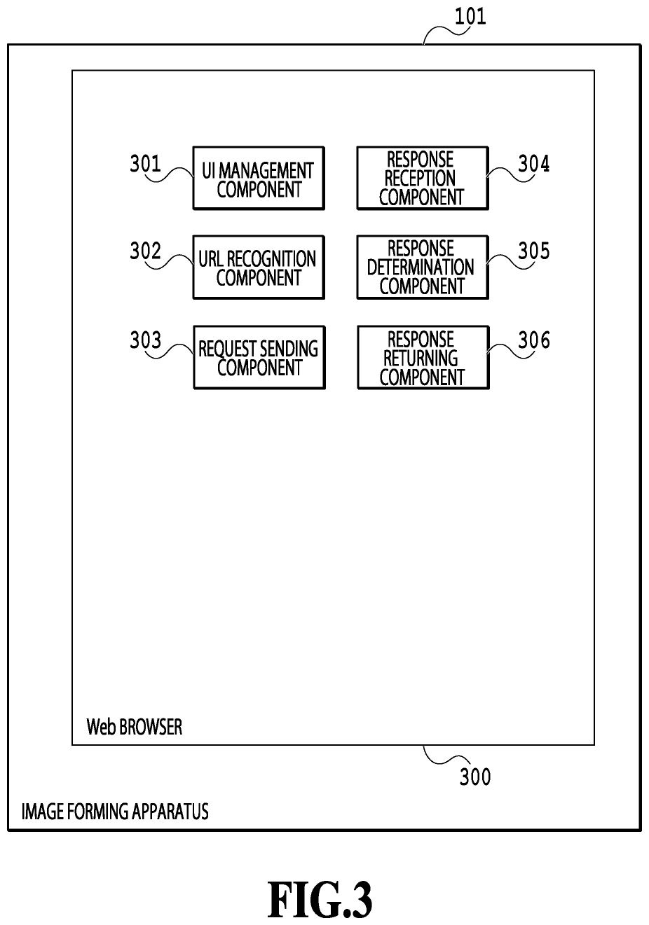

FIG. 3 is a diagram illustrating an example of the software configuration of the image forming apparatus 101. The web browser 300 will now be described with reference to FIG. 3. The image forming apparatus 101 includes the web browser 300 as software which the CPU 211 implements by executing the control programs stored in the ROM 212 of the image forming apparatus 101. The web browser 300 has a user interface (UI) management component 301, a URL recognition component 302, a request sending component 303, a response reception component 304, a response determination component 305, and a response returning component 306.

The UI management component 301 manages UIs included in the web browser 300, such as a URL box, a reload button, a forward button, a back button, and stop button, and determines whether the user has operated the UIs. The URL recognition component 302 determines whether a URL designated by the user matches the URL indicating the storage location of the currently displayed web content. The URL recognition component 302 also saves the URL designated by the user in a URL information table to be described later that is saved in the RAM 213 or the like, and reads a saved URL out of the URL information table. The request sending component 303 sends requests to the server 102. The response reception component 304 receives web contents returned by the server 102 as responses. The response reception component 304 also displays the result of rendering of a web content thus received on the liquid crystal display unit of the operation unit 219. The response determination component 305 determines what a content of the response of the web content received by the response reception component 304 indicates. The response returning component 306 returns the web content received by the response reception component 304 as a response.

(Processing in Case where URL is Input into URL Box or Reload Button is Pressed)

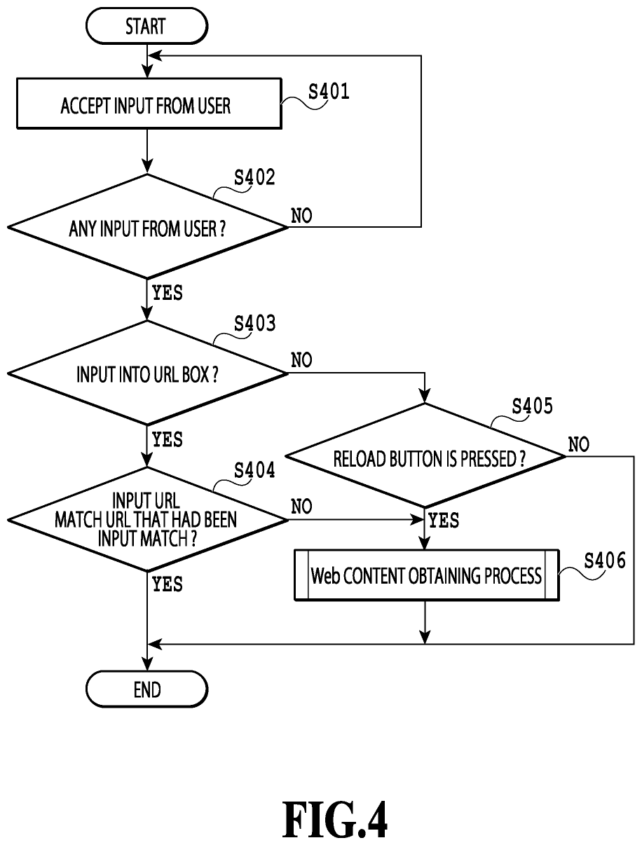

FIG. 4 is a flowchart illustrating an example of processing to be executed by the web browser 300 of the image forming apparatuses 101 in a case where the user inputs a URL into the URL box or presses the reload button. The processing to be executed by the web browser 300 in the present embodiment will now be described with reference to FIG. 4. Incidentally, in the present embodiment, the image forming apparatus 101 is exemplarily described as an MFP. The present embodiment is not limited to this example. The same applies also to the other embodiments. The CPU 211 of the image forming apparatus 101 implements the processing illustrated in FIG. 4 by loading a program stored in the ROM 212 or the like to the RAM 213 and executing it. Incidentally, the functions of some or all of the steps in FIG. 4 may be implemented with hardware such as an application-specific integrated circuit (ASIC) or an electronic circuit. The symbol “S” in the description of each process means a step in the flowchart (the same applies to the other flowcharts herein). The processing illustrated in FIG. 4 starts in a case where the web browser 300 is launched from a menu screen not illustrated that is displayed in response to powering on the image forming apparatus 101.

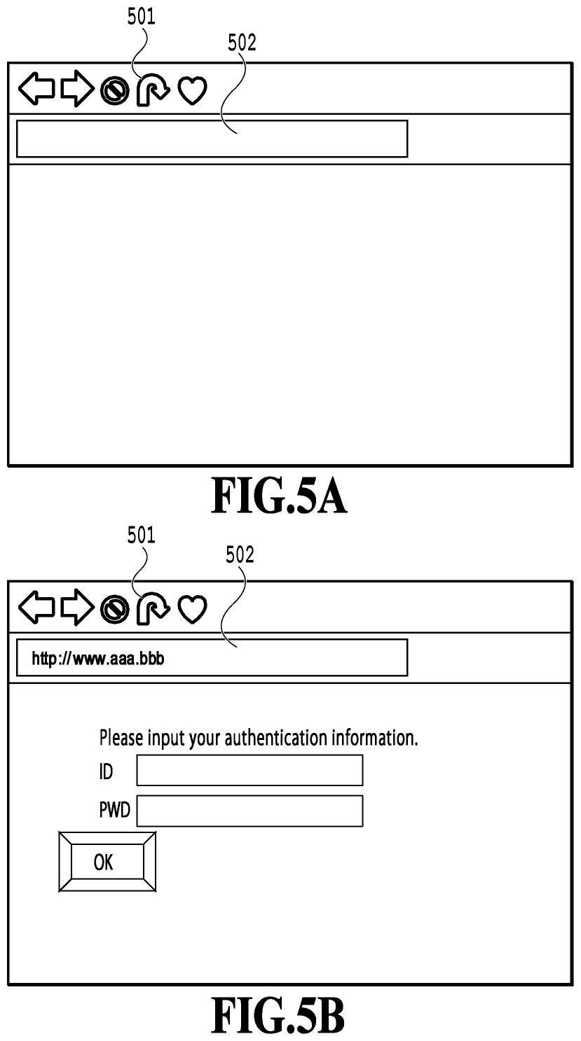

In S401, using the UI management component 301, the CPU 211 accepts an input into the web browser 300 from the user. Specifically, the CPU 211 displays a screen of the web browser 300 as illustrated in FIG. 5A and accepts an input from the user. FIG. 5A is a diagram illustrating an example of the screen displayed in a case where the web browser 300 is launched. The screen of the web browser 300 in FIG. 5A has a reload button 501 and a URL box 502. The reload button 501 functions as an update acceptance unit that accepts an instruction to update the resources of a web content. The URL box 502 functions as an acceptance unit that accepts input of a URL to browse a web page a web page which the user wishes to browse. Referring back to FIG. 4, the CPU 211 then proceeds to the process of S402.

In S402, using the UI management component 301, the CPU 211 determines whether there has been an input into the web browser 300 from the user. The CPU 211 proceeds to the process of S403 if determining that there has been an input from the user (Yes) and, if not (No), proceeds to the process of S401. That is, the CPU 211 continues the process of S402 until there is an input from the user. In S403, using the UI management component 301, the CPU 211 determines whether there was an input into the URL box 502 from the user when determining there was an input in S402. For example, the CPU 211 may determine that there was an input into the URL box 502 in a case where an URL was input into the URL box 502 and the enter key was pressed to confirm that input. Also, in a case where the user performs a pressing action on the URL box 502 in which an URL has already been input, a keyboard is displayed on the operation unit. The CPU 211 may determine that there was an input into the URL box 502 in a case where the user pressed the enter key of the displayed keyboard. Also, even in a case where a URL's scheme part (such as http://) was not input into the URL box 502, the CPU 211 may add the scheme part and determine that a URL was input. The CPU 211 proceeds to the process of S404 if determining that there was an input into the URL box 502 from the user (Yes) and, if not (No), proceeds to the process of S405.

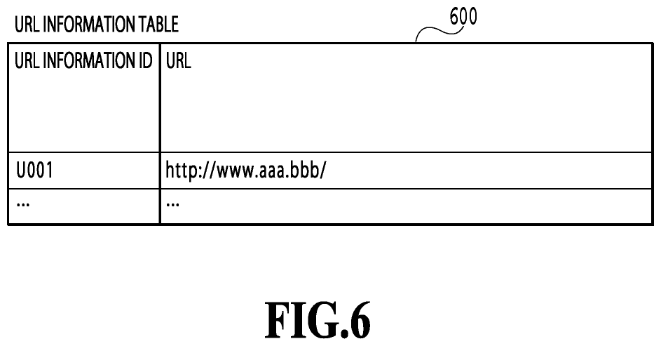

In S404, using the URL recognition component 302, the CPU 211 reads the URL that had been input out of the URL information table saved in the HDD 214, the RAM 213, or the like. Here, the URL that had been input means the last URL input in the URL box before the URL input in S402 and managed in the URL information table. For example, the CPU 211 reads the URL out of a URL information table 600 as illustrated in FIG. 6.

FIG. 6 is a diagram illustrating an example of the URL information table. In the URL information table 600, URLs input in the URL box 502 are associated with respective URL information IDs and managed. Note that the method of managing input URLs is not limited to this method. That is, how URLs are saved and managed is not limited as long as the CPU 211 can determine whether an input URL matches the URL that had been input. Referring back to FIG. 4, using the URL recognition component 302, the CPU 211 determines whether the URL input into the URL box by the user in S403 matches the URL that had been input. Note that the CPU 211 may determine whether the URL input into the URL box by the user in S403 matches the URL that had been input regardless of whether the URL's scheme part (such as http://) is input or not. Specifically, in a case where “http://www.aaa.bbb” has already been input in the URL box and “www.aaa.bbb” is subsequently input, the CPU 211 may determine the input URL matches the URL that had been input. The CPU 211 terminates the processing if determining that the input URL matches the URL that had been input (Yes) and, if not (No), proceeds to the process of S406. Note that the URL information table 600 is empty when the web browser 300 is launched. Thus, in a case where no URL has been input before the input of the URL accepted in S402 after the launch of the web browser 300, the CPU 211 proceeds to the process of S406. Incidentally, in a case where a page to be displayed at launch of the web browser 300 has been set, the URL to browse the set page may be saved in the URL information table 600. In this case, the CPU 211 determines whether the URL to browse the set page and the URL input into the URL box match.

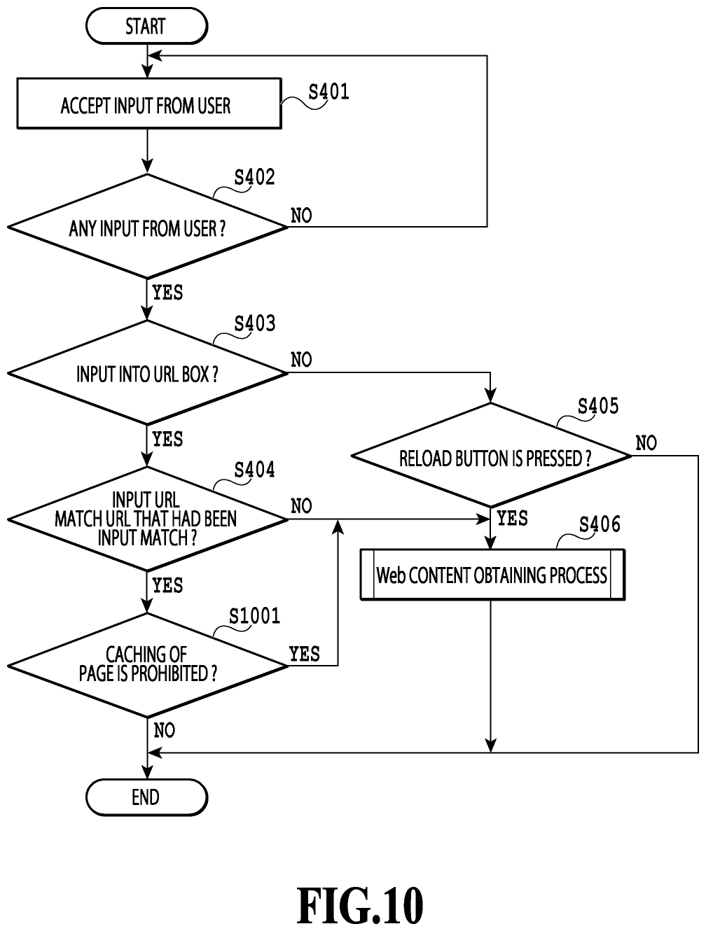

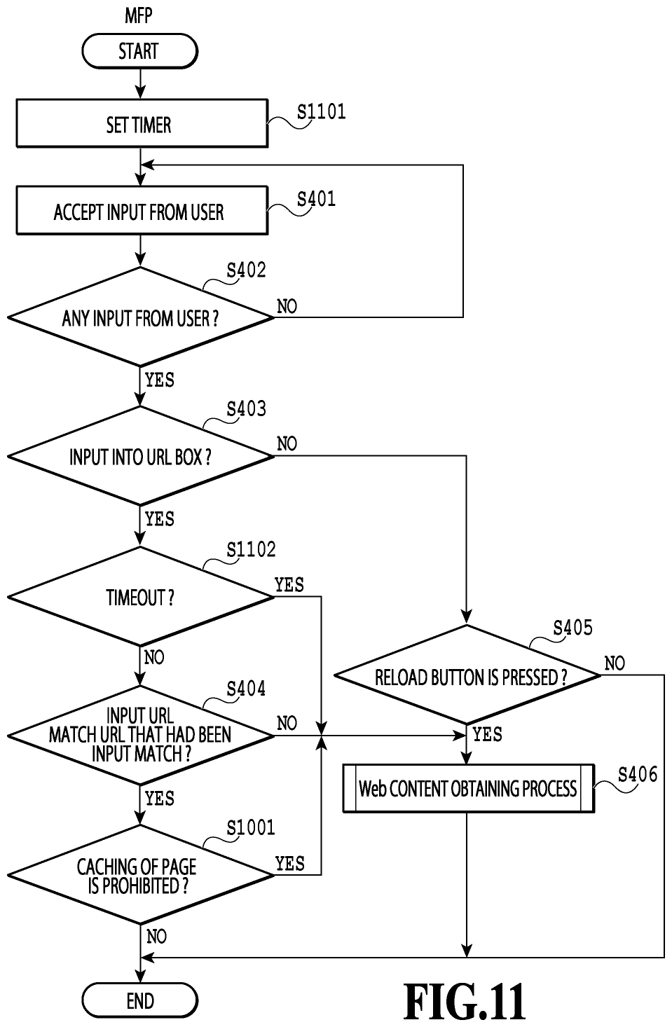

In S405, using the UI management component 301, the CPU 211 determines whether the user has pressed the reload button. The CPU 211 proceeds to S406 if determining that the user has pressed the reload button 501 (Yes) and, if not (No), terminates the processing. In S406, the CPU 211 performs a web content obtaining process using the request sending component 303, the response reception component 304, and the response determination component 305, and then terminates the processing. Incidentally, in the present embodiment, even in a case where the processing illustrated in FIG. 4 is terminated, this processing will be continued as long as the image forming apparatus 101 is not powered off. That is, after the processing is terminated, the CPU 211 returns to S401 (not illustrated) and repeats the processing. The same applies also to the processing in FIG. 10 and the processing in FIG. 11 to be described later.

### (Web Content Obtaining Process)

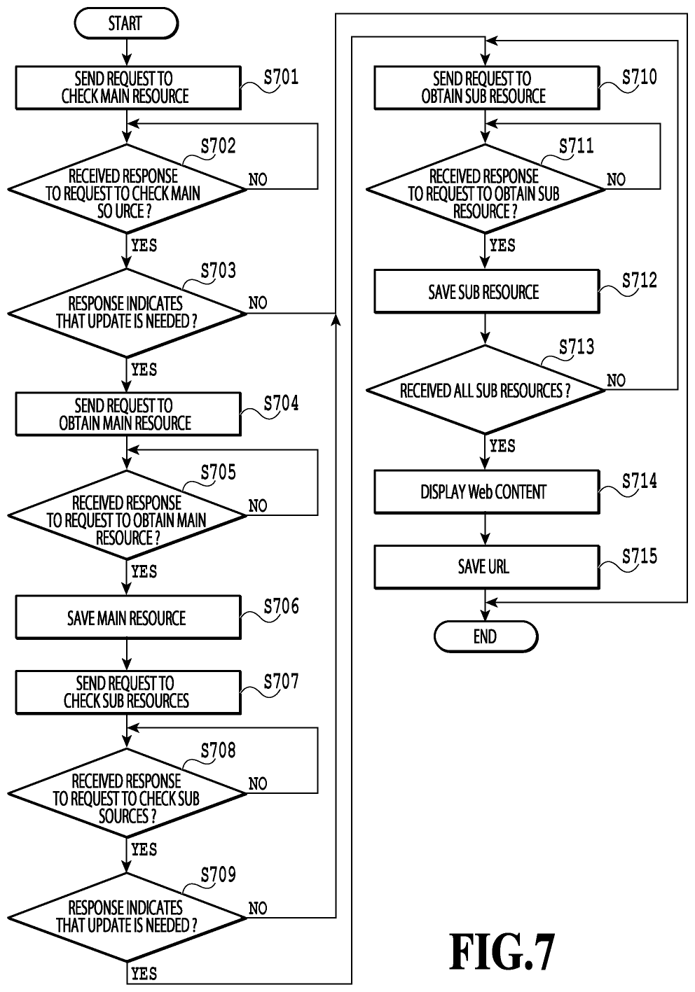

FIG. 7 is a flowchart illustrating an example of the web content obtaining process executed by the web browser 300 in S406. A process in which the web browser 300 of the image forming apparatus 101 in the present embodiment sends a request to the server 102 specified by a designated URL and obtains a web content from the server 102 will now be described with reference to FIG. 7.

In S701, using the request sending component 303, the CPU 211 sends a request to check for an update for a main resource to the server 102 specified by the URL input in S403. The CPU 211 then proceeds to the process of S702. In S702, using the response reception component 304, the CPU 211 determines whether a response to the request to check for an update for the main resource has been received from the server 102. The CPU 211 proceeds to the process of S703 if determining that a response to the request to check for an update for the main resource has been received from the server 102 (Yes) and, if not (No), proceeds to the process of S702. That is, the CPU 211 continues the process of S702 until receiving a response to the request to check for an update for the main resource.

In S703, using the response determination component 305, the CPU 211 determines whether the response received from the server 102 in S702 indicates that the main resource needs to be updated. The CPU 211 proceeds to the process of S704 if determining that the response received from the server 102 indicates that the main resource needs to be updated (Yes) and, if not (No), terminates the processing. Note that, before the input of a URL in S402, the same URL may not have been input. In this case, the CPU 211 does not need to execute the processes of S701 to S703. Here, checking for an update for the main resource is a process in which, in a case where the main resource of the URL that had been input has been cached, it is checked whether the cached main resource needs to be updated. In other words, in a case where there is no cached main resource, the processes of S701 to S703 do not need to be executed.

In S704, using the request sending component 303, the CPU 211 sends a request to obtain the main resource to the server 102. The CPU 211 then proceeds to the process of S705. In S705, using the response reception component 304, the CPU 211 determines whether a response to the request to obtain the main resource has been received from the server 102. The CPU 211 proceeds to the process of S706 if determining that a response to the request to obtain the main resource has been received from the server 102 (Yes) and, if not (No), proceeds to the process of S705. That is, the CPU 211 continues the process of S705 until receiving a response to the request to obtain the main resource. In S706, using the response reception component 304, the CPU 211 saves the main resource received in S705 in the HDD 214, the RAM 213, or the like. The CPU 211 then proceeds to the process of S707.

In S707, using the request sending component 303, the CPU 211 sends a request to check for updates for sub resources to the server 102. The CPU 211 then proceeds to the process of S708. In S708, using the response reception component 304, the CPU 211 determines whether a response to the request to check for updates for the sub resources has been received from the server 102. The CPU 211 proceeds to the process of S709 if determining that a response to the request to check for updates for the sub resources has been received from the server 102 (Yes) and, if not (No), proceeds to the process of S708. That is, the CPU 211 continues the process of S708 until receiving a response to the request to check for updates for the sub resources.

In S709, using the response determination component 305, the CPU 211 determines whether the response received from the server 102 in S708 indicates that any of the sub resource needs to be updated. The CPU 211 proceeds to the process of S710 if determining that the response received from the server 102 indicates that one or more of the sub resources need to be updated (Yes) and, if not (No), terminates the processing. Incidentally, in a case where there is no cached sub resource, the processes of S707 to S709 do not need to be executed for a similar reason to that for the processes of S701 to S703 described above.

In S710, using the request sending component 303, the CPU 211 sends a request to obtain a sub resource to the server 102. The CPU 211 then proceeds to the process of S711. In S711, using the response reception component 304, the CPU 211 determines whether a response to the request to obtain a sub resource has been received from the server 102. The CPU 211 proceeds to the process of S712 if determining that a response to the request to obtain a sub resource has been received from the server 102 (Yes) and, if not (No), proceeds to the process of S711. That is, the CPU 211 continues the process of S711 until receiving a response to the request to obtain a sub resource. In S712, using the response reception component 304, the CPU 211 saves the sub resource received in S711 in the HDD 214, the RAM 213, or the like. The CPU 211 then proceeds to the process of S713.

In S713, using the response reception component 304, the CPU 211 determines whether all sub resources have been received in S711. The CPU 211 proceeds to the process of S714 if determining that all sub resources have been received (Yes) and, if not (No), proceeds to the process of S710. That is, the CPU 211 continues the processes of S710 to S713 until receiving all sub resources. In S714, using the UI management component 301, the CPU 211 reads the main resource saved in S706 and the sub resources saved in S712 out of the HDD 214, the RAM 213, or the like. Then, using the UI management component 301, the CPU 211 displays a rendering result on the display of the operation unit 219. The CPU 211 then proceeds to the process of S715. In S715, using the URL recognition component 302, the CPU 211 saves the URL input in S402 in the URL information table 600 saved in the HDD 214, the RAM 213, or the like, and then terminates the processing.

### Application Example 1

As an application example of the processing in FIGS. 4 and 7 described above, a case will be described in which the user inputs a URL into the URL box, the web browser 300 then accesses the server 102 specified by the input URL and obtains a web content, and the user thereafter inputs the same URL again.

### (First Processing in Application Example 1)

First processing executed by the web browser will now be described with reference to FIGS. 4 and 7. Note that, at the start of this processing, the screen of the web browser 300 is in the state illustrated in FIG. 5A. Moreover, the URL information table 600 in FIG. 6 is in a blank state containing nothing. Also, the URL of the server 102 is “http://www.aaa.bbb”. First, referring to FIG. 4, the processing is started in a case where the web browser 300 is launched, and the CPU 211 executes the process of S401.

In S401, using the UI management component 301, the CPU 211 accepts an input into the web browser 300 from the user. At this time, the state of the screen of the web browser 300 is such that the URL box 502 is blank, as illustrated in FIG. 5A, and accepts the input from the user. The CPU 211 then proceeds to the process of S402.

In S402, using the UI management component 301, the CPU 211 determines whether there has been an input into the web browser 300 from the user. Suppose that the user has input “http://www.aaa.bbb”, which is the URL of the server 102, into the URL box 502. In this case, the CPU 211 proceeds to the process of S403 since the user has input a URL (first URL) into the URL box 502 in FIG. 5A. In S403, using the UI management component 301, the CPU 211 determines whether there was an input into the URL box from the user when an input was detected in S402. The CPU 211 proceeds to the process of S404 since the user input a URL into the URL box 502 in FIG. 5A, as mentioned above.

In S404, using the URL recognition component 302, the CPU 211 reads the URL that had been input out of the URL information table 600 saved in the HDD 214, the RAM 213, or the like. Here, the URL information table 600 is in a blank state in which nothing is saved. Thus, the CPU 211 reads out information indicating the blank state as the URL that had been input (second URL). Then, using the URL recognition component 302, the CPU 211 determines whether the URL input into the URL box by the user in S402 (“http://www.aaa.bbb”) matches the URL that had been input (the information indicating the blank state). Here, the CPU 211 determines that the URLs do not match, and proceeds to the process of S406. In S406, the CPU 211 performs a web content obtaining process using the request sending component 303, the response reception component 304, and the response determination component 305, and then terminates the processing.

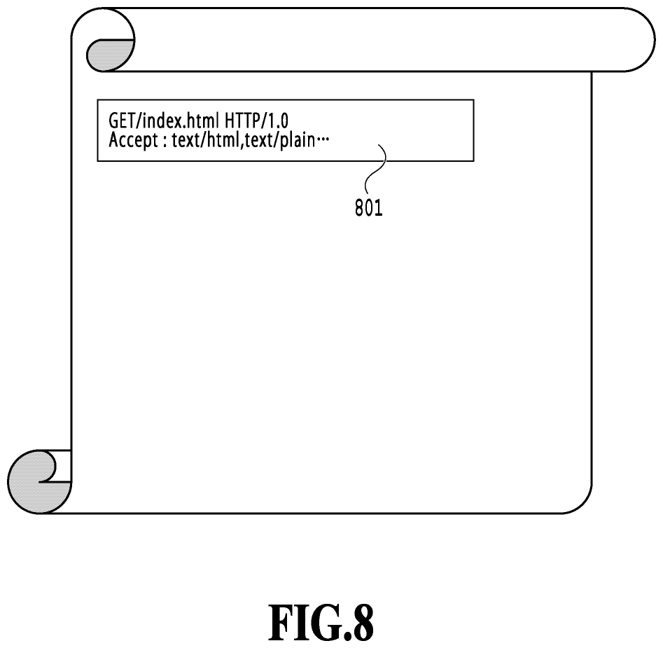

Next, details of the web content obtaining process will be described with reference to FIG. 7. In S701, using the request sending component 303, the CPU 211 sends a request to check for an update for the main resource to the server 102 specified by the URL input in S402. Specifically, the CPU 211 sends a request to check for an update for the main resource as illustrated in FIG. 8 to the server 102 specified by the URL input in S402, or “http://www.aaa.bbb”. FIG. 8 is a diagram illustrating an example of the request sent by the web browser 300. The request in FIG. 8 includes a request header 801. The request header 801 describes information such as the data type that the image forming apparatus 101 can process. Referring back to FIG. 7, the CPU 211 then proceeds to the process of S702.

In S702, using the response reception component 304, the CPU 211 determines whether a response to the request to check for an update for the main resource has been received from the server 102. Here, suppose that the CPU 211 determines that a response to the request to check for an update for the main resource has been received from the server 102. Thus, the CPU 211 proceeds to the process of S703. In S703, using the response determination component 305, the CPU 211 determines whether the response received from the server 102 in S702 indicates that the main resource needs to be updated. Here, suppose that the CPU 211 determines that the response received from the server 102 indicates that the main resource needs to be updated. Thus, the CPU 221 proceeds to the process of S704. In S704, using the request sending component 303, the CPU 211 sends a request to obtain the main resource to the server 102. The CPU 211 then proceeds to the process of S705.

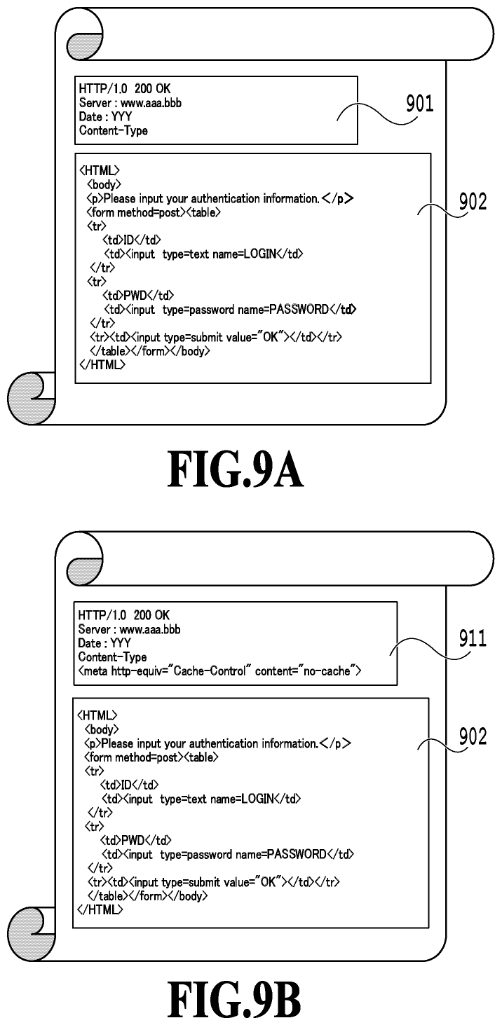

In S705, using the response reception component 304, the CPU 211 determines whether a response to the request to obtain the main resource has been received from the server 102. Specifically, the CPU 211 receives a response as illustrated in FIG. 9A. FIG. 9A is a diagram illustrating an example of the response received by the web browser 300. The response in FIG. 9A has a response header 901 and a response body 902. The response header 901 describes the result of the request sent in S704 and the date on which the server 102 returned the response. The response header 901 may also describe information to notify of the date and time of the last update of the resource, Etag, or the like to be used to check for an update for the resource next time. The response body 902 describes the main resource. Here, suppose that the CPU 211 determines that a response to the request to obtain the main resource has been received from the server 102. Thus, the CPU 211 proceeds to the process of S706.

In S706, using the response reception component 304, the CPU 211 saves the main resource received in S705 in the HDD 214, the RAM 213, or the like. The CPU 211 then proceeds to the process of S707. In S707, using the request sending component 303, the CPU 211 sends a request to check for updates for the sub resources to the server 102. The CPU 211 then proceeds to the process of S708. In S708, using the response reception component 304, the CPU 211 determines whether a response to the request to check for updates for the sub resources has been received from the server 102. Here, suppose that the CPU 211 has received a response to the request to check for updates for the sub resources has been received from the server 102. Thus, the CPU 211 proceeds to the process of S709.

In S709, using the response determination component 305, the CPU 211 determines whether the response received from the server 102 in S708 indicates that any of the sub resource needs to be updated. Here, suppose that the CPU 211 determines that the response received from the server 102 indicates that one or more of the sub resources need to be updated. Thus, the CPU 221 proceeds to the process of S710. In S710, using the request sending component 303, the CPU 211 sends a request to obtain a sub resource to the server 102. The CPU 211 then proceeds to the process of S711.

In S711, using the response reception component 304, the CPU 211 determines whether a response to the request to obtain a sub resource has been received from the server 102. Here, suppose that the CPU 211 determines that a response to the request to obtain a sub resource has been received from the server 102. Thus, the CPU 211 proceeds to the process of S712. Note that the response to the request to obtain a sub resource may describe information to notify of the date and time of the last update of the resource, Etag, or the like that is to be used to check for an update for the resource next time. In S712, using the response reception component 304, the CPU 211 saves the sub resource received in S711 in the HDD 214, the RAM 213, or the like. The CPU 211 then proceeds to the process of S713. In S713, using the response reception component 304, the CPU 211 determines whether all sub resources have been received in S711. Here, suppose that the CPU 211 determines that all sub resources have been received. Thus, the CPU 211 proceeds to the process of S714.

In S714, using the UI management component 301, the CPU 211 reads the main resource saved in S706 and the sub resources saved in S712 out of the HDD 214, the RAM 213, or the like. Also, using the UI management component 301, the CPU 211 displays a rendering result on the display of the operation unit 219. Here, the CPU 211 displays a rendering result screen as illustrated in FIG. 5B on the display of the operation unit 219. FIG. 5B is a diagram illustrating an example of the web browser 300 in which a URL has been input and a web page has been displayed. Referring back to FIG. 4, the CPU 211 then proceeds to the process of S715. In S715, using the URL recognition component 302, the CPU 211 saves the URL input in S402, or “http://www.aaa.bbb”, in the URL information table 600 saved in the HDD 214, the RAM 213, or the like, and then terminates the processing.

### (Second Processing in Application Example 1)

Next, the CPU 211 starts the processing in FIG. 4 again with the URL “http://www.aaa.bbb” input in the URL box 502 in the display screen of the web browser 300. In S401, using the UI management component 301, the CPU 211 accepts an input into the web browser 300 from the user. That is, as illustrated in FIG. 5B, the CPU 211 accepts an input from the user in the state where “http://www.aaa.bbb” input in the URL box 502 is displayed. The CPU 211 then proceeds to the process of S402.

In S402, using the UI management component 301, the CPU 211 determines whether there has been an input into the web browser 300 from the user. Here, suppose that the user inputs “http://www.aaa.bbb”, which is the same URL as the URL that has already been displayed, into the URL box 502. As a result, “http://www.aaa.bbb” is displayed in the URL box, as illustrated in the URL box 502 in FIG. 5B. The CPU 211 proceeds to the process of S403 since the user has input a URL (first URL) into the URL box 502 in FIG. 5B. In S403, using the UI management component 301, the CPU 211 determines whether there was an input into the URL box from the user when an input was detected in S402 immediately preceding S403. The CPU 211 proceeds to the process of S404 since the user input a URL into the URL box 502 in FIG. 5B, as mentioned above.

In S404, using the URL recognition component 302, the CPU 211 reads the URL that had been input (second URL) out of the URL information table 600 saved in the HDD 214, the RAM 213, or the like. Here, the CPU 211 reads the URL “http://www.aaa.bbb” out of the URL information table 600 as the URL that had been input. Then, using the URL recognition component 302, the CPU 211 determines whether the URL input into the URL box (“http://www.aaa.bbb”) matches the URL that had been input (“http://www.aaa.bbb”). Here, the CPU 211 determines that the URLs match, and terminates the processing. Specifically, in the second processing in Application Example 1, the URL input by the user is the same as the URL that had been input. For this reason, the CPU 211 does not perform the web content obtaining process in S406.

### Application Example 2

As an application example of the processing in FIGS. 4 and 7 described above, a case will be described in which the user accesses the server 102 specified by a URL designated in the URL box 502, obtains a web content, and then presses the reload button 501.

### (First Processing in Application Example 2)

This processing starts in a similar state to that in the first processing in Application Example 1. Note that the processing is similar to the first processing in Application Example 1, and description of the flowcharts of FIGS. 4 and 7 is therefore omitted.

### (Second Processing in Application Example 2)

This processing starts in a similar state to that in the second processing in Application Example 1. In S401, using the UI management component 301, the CPU 211 accepts an input into the web browser 300 from the user. Here, the screen of the web browser 300 is in a state where the URL that has been input, or “http://www.aaa.bbb”, is displayed in the URL box 502, as illustrated in FIG. 5B. In S402, using the UI management component 301, the CPU 211 determines whether there has been an input into the web browser 300 from the user. Here, suppose that the user presses the reload button 501 in FIG. 5B. In response to the user pressing the reload button 501, the CPU 211 proceeds to the process of S403.

In S403, using the UI management component 301, the CPU 211 determines whether there was an input into the URL box from the user when an input was detected in S402 immediately preceding S403. As mentioned above, the user pressed the reload button 501 in FIG. 5B. Thus, the CPU 211 determines that there was no input into the URL box 502, and proceeds to the process of S405. In S405, using the UI management component 301, the CPU 211 determines whether the user pressed the reload button when the input was detected in S402. As mentioned above, the user pressed the reload button 501 in FIG. 5B. Thus, the CPU 211 proceeds to the process of S406. In S406, the CPU 211 performs a web content obtaining process using the request sending component 303, the response reception component 304, and the response determination component 305, and then terminates the processing.

The processing in the flowchart of FIG. 7 as the second processing in Application Example 2 is similar to the first processing in Application Example 1, and description is therefore omitted. That is, in the second processing in Application Example 2, the CPU 211 performs the web content obtaining process in S406 in a case where the user presses the reload button 501, regardless of the content of the URL that has already been input.

As described in Application Example 1 above, in a case where the user inputs a URL into the URL box 502 in FIG. 5A, the web browser displays a web content. In a case where the user then inputs the same URL into the URL box 502 in FIG. 5B, the web browser does not access the server or read the cache but continues displaying the current web content. Also, as mentioned in the description of the first processing in Application Example 1, in a case where the URL input by the user is different from the URL of the currently displayed web content, the web browser accesses the server and checks whether the web content has been updated. As described in Application Example 2 above, the web browser accesses the server and checks whether the web content has been updated also in a case where the user presses the reload button 501.

In accordance with the present embodiment, in a case where the user inputs a URL into the URL box and a web content is displayed, and the user then inputs the same URL as the URL already input in the URL box, the web browser neither accesses the server nor reads the cache. In this way, there is no waiting time required to display the web content again. Accordingly, user-friendliness is improved. Also, in a case where the user inputs a URL different from the URL that has already been input or the user presses the reload button, which issues an instruction to update the resources of the web content, the web content will be displayed appropriately.

### Second Embodiment

A case where the web browser 300 obtains a web content from the server 102 and caching of the web content is prohibited will be described with reference to FIG. 10 while also discussing the difference from the first embodiment. Note that, in the present embodiment, the same block diagrams and the processes in the same flowchart as those in the first embodiment will be described with the same reference signs unless otherwise noted.

(Processing in Case where URL is Input into URL Box or Reload Button is Pressed)

FIG. 10 is a flowchart illustrating an example of processing to be executed by the web browser 300 of the image forming apparatuses 101 in a case where the user inputs a URL into the URL box or presses the reload button. The processing to be executed by the web browser 300 in the present embodiment will now be described with reference to FIG. 10. As in the first embodiment, the processing in FIG. 10 starts in a case where the web browser 300 is launched from the menu screen not illustrated that is displayed in response to powering on the image forming apparatus 101, and ends in a case where the image forming apparatus 101 is powered off. Note that the processes of S401 to S406 are similar to those in the first embodiment, and description thereof is therefore omitted.

In S1001, using the response determination component 305, the CPU 211 determines whether caching of the web content received in S406 is prohibited. The CPU 211 proceeds to the process of S406 if determining that caching of the web content received in S406 is prohibited (Yes) and, if not (No), terminates the processing.

### Application Example 3

As an application example of the processing in FIGS. 10 and 7 described above, a case will be described in which the web browser 300 accesses the server 102 specified by a URL designated in the URL box by the user and obtains a web content, and the user inputs the same URL again while caching of the web content is prohibited.

In the present application example too, the URL information table 600 in FIG. 6 is in a blank state containing nothing. Also, in the present application example, the processing starts with the screen of the web browser 300 in a state immediately after launching the web browser 300, i.e., the state of FIG. 5A. Also, in present application example, the URL of the server 102 is “http://www.aaa.bbb”.

### (First Processing in Application Example 3)

The first processing in Application Example 3 is similar to the first processing in Application Example 1 described above, and description thereof is therefore omitted. That is, suppose that the user inputs the URL “http://www.aaa.bbb” into the URL box 502 in FIG. 5A, and the CPU 211 proceeds to the web content obtaining process in S406. Also, while the web content obtaining process in S406 will be described with reference to FIGS. 7, S701 to S704 and S706 to S715 are similar to those in the first processing in Application Example 1 described above, and description thereof is therefore omitted.

In S705, using the response reception component 304, the CPU 211 determines whether a response to the request to obtain the main resource has been received from the server 102. Here, suppose that the CPU 211 determines that a response as illustrated in FIG. 9B has been received as a response to the request to obtain the main resource from the server 102. Thus, the CPU 211 proceeds to the process of S706. FIG. 9B is a diagram illustrating an example of the response received by the web browser 300. A response header 911 in FIG. 9B describes a setting “<meta http-equiv=“Cache-Control” content=“no-cache”>”. This is a setting indicating that caching of this web content is prohibited.

### (Second Processing in Application Example 3)

Next, the CPU 211 starts the processing in FIG. 10 again with the URL “http://www.aaa.bbb” input in the URL box 502 in the display screen of the web browser 300. In S401, using the UI management component 301, the CPU 211 accepts an input into the web browser 300 from the user. That is, as illustrated in FIG. 5B, the CPU 211 accepts an input from the user in the state where “http://www.aaa.bbb” input in the URL box 502 is displayed. The CPU 211 then proceeds to the process of S402.

In S402, using the UI management component 301, the CPU 211 determines whether there has been an input into the web browser 300 from the user. Here, suppose that the user inputs “http://www.aaa.bbb”, which is the same URL as the URL that has already been displayed, into the URL box 502. As a result, “http://www.aaa.bbb” is displayed in the URL box, as illustrated in the URL box 502 in FIG. 5B. The CPU 211 proceeds to the process of S403 since the user has input a URL into the URL box 502 in FIG. 5B, as mentioned above. In S403, using the UI management component 301, the CPU 211 determines whether there was an input into the URL box from the user when an input was detected in S402 immediately preceding S403. The CPU 211 proceeds to the process of S404 since the user input a URL into the URL box 502 in FIG. 5B, as mentioned above.

In S404, using the URL recognition component 302, the CPU 211 reads the URL that had been input out of the URL information table 600 saved in the HDD 214, the RAM 213, or the like. Here, the CPU 211 reads the URL “http://www.aaa.bbb” out of the URL information table 600 as the URL that had been input. Then, using the URL recognition component 302, the CPU 211 determines whether the URL input into the URL box by the user (“http://www.aaa.bbb”) matches the URL that had been input (“http://www.aaa.bbb”). Here, the CPU 211 determines that the URLs match, and proceeds to the process of S1001.

In S1001, using the response determination component 305, the CPU 211 determines whether caching of the web content in FIG. 9B received in S705 is prohibited. The response header 911 in FIG. 9B describes a setting “<meta http-equiv=“Cache-Control” content=“no-cache”>”, indicating that caching of the web content is prohibited. For this reason, the CPU 211 determines that caching of the web content is prohibited, and proceeds to the process of S406. In S406, the CPU 211 performs a web content obtaining process using the request sending component 303, the response reception component 304, and the response determination component 305. The CPU 211 then terminates the processing. The web content obtaining process in FIG. 10 is similar to that in the first processing in Application Example 3 described above, and description thereof is therefore omitted. In the second processing in Application Example 3, the web browser 300 performs the web content obtaining process in S406 in a case where caching of the web content is prohibited.

There is a web content specification by which, in a case where caching of a web content is prohibited, the web browser accesses the server and checks whether the web content has been updated. In the first embodiment, in the case where caching of a web content is prohibited, the web browser 300 neither accesses the server nor reads a cache but displays the current web content if the same URL is input into the URL box. That is, in the first embodiment, in the case where coaching of a web content is prohibited, the web browser 300 performs a process equivalent to a process of displaying the web content out of a cache, which may not satisfy the web content specification mentioned above. In the present embodiment, in the case where caching of a web content is prohibited, the web browser accesses the server and checks whether the web content has been updated. Accordingly, the web browser can implement a process that is more appropriate for the web content specification mentioned above.

### Third Embodiment

A case where the web browser 300 obtains a web content from the server 102 and the user inputs the same URL into the URL box after the web browser 300 is left untouched for a certain period of time will be described with reference to FIG. 11 while also discussing the difference from the second embodiment. In the present embodiment, the block diagrams with the same numbers and the processes in the same flowchart as those in the second embodiment will be described with the same reference signs unless otherwise noted.

(Processing in Case where URL is Input into URL Box or Reload Button is Pressed)

FIG. 11 is a flowchart illustrating an example of processing to be executed by the web browser 300 of the image forming apparatuses 101 in a case where the user inputs a URL into the URL box or presses the reload button. The processing to be executed by the web browser 300 in the present embodiment will now be described with reference to FIG. 11. As in the second embodiment, the processing in FIG. 11 starts in a case where the web browser 300 is launched from the menu screen not illustrated that is displayed in response to powering on the image forming apparatus 101, and ends in a case where the image forming apparatus 101 is powered off. Note that the processes of S401 to S406 and S1001 are similar to those in the second embodiment, and description thereof is therefore omitted.

In S1101, using the UI management component 301, the CPU 211 sets a timer for measuring the time from acceptance of an input into the URL box from the user until acceptance of another input. The CPU 211 then proceeds to the process of S401. In S1102, using the UI management component 301 and the timer set in S1101, the CPU 211 measures the time from the acceptance of the input into the URL box from the user until the acceptance of a next input into the URL box from the user. Then, using the UI management component 301, the CPU 211 determines whether or not the measured time is more than or equal to a given threshold value (first threshold value). Specifically, if determining that the measured time is more than or equal to the given threshold value, the CPU 211 determines that a timeout has occurred (Yes) and proceeds to the process of S406 and, if not (No), proceeds to the process of S404.

### Application Example 4

As an application example of the processing in FIGS. 11 and 7 described above, a case will be described in which the web browser 300 accesses the server 102 specified by a URL designated in the URL box by the user and obtains a web content, and the user then inputs the same URL into the URL box after the web browser 300 is left untouched for a certain period of time.

In the present application example too, the URL information table 600 in FIG. 6 is in a blank state containing nothing. Also, in the present application example, the processing starts with the screen of the web browser 300 in a state immediately after launching the web browser 300, i.e., the state of FIG. 5A. Also, in present application example, the URL of the server 102 is “http://www.aaa.bbb”.

### (First Processing in Application Example 4)

The first processing in Application Example 4 will now be described with reference to FIG. 11. In S1101, using the UI management component 301, the CPU 211 sets the timer for measuring the time from acceptance of an input into the URL box from the user until acceptance of another input. The CPU 211 then proceeds to the process of S401.

In S401, using the UI management component 301, the CPU 211 accepts an input into the web browser 300 from the user. At this time, the state of the screen of the web browser 300 is such that the URL box 502 is blank, as illustrated in FIG. 5A, and accepts the input from the user. The CPU 211 then proceeds to the process of S402.

In S402, using the UI management component 301, the CPU 211 determines whether there has been an input into the web browser 300 from the user. Here, suppose that the user has input “http://www.aaa.bbb”, which is the URL of the server 102, into the URL box 502. The CPU 211 proceeds to the process of S403 since the user has input a URL into the URL box 502 in FIG. 5A.

In S403, using the UI management component 301, the CPU 211 determines whether there was an input into the URL box from the user when an input was detected in S402. The CPU 211 transitions to the process of S1102 since the user input a URL into the URL box 502 in FIG. 5A, as mentioned above. Here, the CPU 211 may save the time from the setting of the timer in S1101 until the acceptance of the input into the URL box from the user.

In S1102, using the UI management component 301 and the timer set in S1101, the CPU 211 measures the time from the acceptance of the input into the URL box from the user until the acceptance of a next input into the URL box from the user. Here, before the input of the URL in S402, the URL box 502 is in a blank state. That is, the CPU 211 has not accepted input of a second URL necessary to measure the above time. In this case, the CPU 211 proceeds to the process of S404 without measuring the time.

In S404, using the URL recognition component 302, the CPU 211 reads the URL that had been input out of the URL information table 600 saved in the HDD 214, the RAM 213, or the like. Here, the URL information table 600 is in a blank state in which nothing is saved. Thus, the CPU 211 reads out information indicating the blank state as the URL that had been input. Then, using the URL recognition component 302, the CPU 211 determines whether the URL input into the URL box by the user in S402 (“http://www.aaa.bbb”) matches the URL that had been input (the information indicating the blank state). Here, the CPU 211 determines that the URLs do not match, and proceeds to the process of S406. In S406, the CPU 211 performs a web content obtaining process using the request sending component 303, the response reception component 304, and the response determination component 305, and then terminates the processing. Note that the web content obtaining process is similar to that in the first processing in Application Example 1 described above, and description thereof is therefore omitted.

### (Second Processing in Application Example 4)

Next, the CPU 211 starts the processing in FIG. 11 again with the URL “http://www.aaa.bbb” input in the URL box 502 in the display screen of the web browser 300. In S1101, using the UI management component 301, the CPU 211 sets the timer for measuring the time from acceptance of an input into the URL box from the user until acceptance of another input. The CPU 211 then proceeds to the process of S401.

In S401, using the UI management component 301, the CPU 211 accepts an input into the web browser 300 from the user. That is, as illustrated in FIG. 5B, the CPU 211 accepts an input from the user in the state where “http://www.aaa.bbb” input in the URL box 502 is displayed. The CPU 211 then proceeds to the process of S402.

In S402, using the UI management component 301, the CPU 211 determines whether there has been an input into the web browser 300 from the user. Here, suppose that the user has input “http://www.aaa.bbb”, which is the URL of the server 102, into the URL box 502. The CPU 211 proceeds to the process of S403 since the user has input a URL into the URL box 502 in FIG. 5B.

In S403, using the UI management component 301, the CPU 211 determines whether there was an input into the URL box from the user when an input was detected in S402 immediately preceding S403. The CPU 211 proceeds to the process of S1102 since the user input a URL into the URL box 502 in FIG. 5B, as mentioned above. Here, the CPU 211 may save the time from the setting of the timer in S1101 in the second processing until the acceptance of the input into the URL box from the user in S402 in the second processing.

In S1102, using the UI management component 301 and the timer set in S1102, the CPU 211 measures the time from the acceptance of the input into the URL box from the user until the acceptance of the next input into the URL box from the user. For example, the CPU 211 may measure the above time from the time information of the timer that was saved when the input of a URL into the URL box was detected in S403 in the first processing and the time information of the timer that was saved in S403 in the second processing. Note that, as long as the time from acceptance of an input into the URL box from the user until acceptance of a next input into the URL box from the user can be measured, the method of using the timer and the method of measuring this time with the timer are not limited to the above methods. Here, suppose that the CPU 211 determines that the measured time is more than or equal to the given threshold value, that is, a timeout has occurred, using the UI management component 301. Thus, the CPU 211 proceeds to the process of S406. In S406, the CPU 211 performs a web content obtaining process using the request sending component 303, the response reception component 304, and the response determination component 305, and then terminates the processing. The web content obtaining process in S406 in FIG. 11 is similar to that in the first processing in Application Example 1 described above, and description thereof is therefore omitted.

In the first and second embodiments, in a case where, for example, the web browser is left untouched for a given period of time with a URL input in the URL box and then the same URL is input into the URL box, no web content obtaining process may be performed. Specifically, in this case, in the first and second embodiments, the web browser does not access the server. This leads to a possibility that the displayed web content may become outdated and an updated web content may not be displayed.

In the present embodiment, the web browser measures the time from acceptance of an input into the URL box from the user until acceptance of a next input into the URL box from the user, and determines that a timeout has occurred in a case where a certain period of time elapses. Thereafter, the web browser accesses the server and checks whether the web content has been updated. This makes it possible to reduce the risk of a displayed web content becoming outdated and display an updated web content.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-144766, filed Sep. 6, 2023, which is hereby incorporated by reference herein in its entirety.

What is claimed is:

1. A non-transitory computer-readable storage medium storing a program for causing a computer to perform:
accepting input of a first uniform resource locator (URL); and
executing control to perform a process of obtaining a content available at the first URL in a case where the first URL does not match a second URL that had been input when the input of the first URL was accepted, and not to perform the process of obtaining the content available at the first URL in a case where the first URL matches the second URL.

2. The storage medium according to claim 1, wherein
the program further causes the computer to perform executing control to perform a process of obtaining a content available at the second URL, and
in the case where the first URL matches the second URL, control not to read a cache for the content available at the second URL is executed.

3. The storage medium according to claim 1, wherein in the case where the first URL matches the second URL, control not to access a server specified by the first URL is executed.

4. The storage medium according to claim 1, wherein
the program further causes the computer to perform accepting an instruction to update the content available at the first URL, and
the control to perform the process of obtaining the content available at the first URL is executed in a case where the instruction is accepted.

5. The storage medium according to claim 2, wherein the control to perform the process of obtaining the content available at the first URL is executed in a case where caching of the content available at the second URL is prohibited.

6. The storage medium according to claim 1, wherein
the program further causes the computer to perform setting a timer for obtaining times at which the input of the first URL and the input of the second URL were accepted, and
the control to perform the process of obtaining the content available at the first URL is executed in a case where a time from the acceptance of the input of the second URL until the acceptance of the input of the first URL obtained by the set timer is more than or equal to a first threshold value.

7. The storage medium according to claim 1, wherein the input of the first URL is accepted in a case where the first URL is input into a URL box and an operation item for confirming the input is pressed.

8. The storage medium according to claim 1, wherein the program is installed in an image forming apparatus.

9. An information processing apparatus comprising at least one memory and at least one processor which function as:
an acceptance unit configured to accept input of a first URL; and
a control unit configured to execute control to perform a process of obtaining a content available at the first URL in a case where the first URL does not match a second URL that had been input in the acceptance unit when the acceptance unit accepted the input of the first URL, and not to perform the process of obtaining the content available at the first URL in a case where the first URL matches the second URL.

10. A controlling method of an information processing apparatus comprising the steps of:
accepting input of a first URL; and
executing control to perform a process of obtaining a content available at the first URL in a case where the first URL does not match a second URL that had been input when the input of the first URL was accepted, and not to perform the process of obtaining the content available at the first URL in a case where the first URL matches the second URL.
